(19) United States
(12) Patent Application Publication
(10) Pub. No.: US 2011/0093809 A1
(43) Pub. Date: Apr. 21, 2011

(54) INPUT TO NON-ACTIVE OR NON-PRIMARY WINDOW

(76) Inventor: Michael K. Colby, Spokane, WA (US)

(21) Appl. No.: 12/908,849

(22) Filed: Oct. 20, 2010

Related U.S. Application Data
(60) Provisional application No. 61/253,477, filed on Oct. 20, 2009.

(51) Int. Cl. G06F 3/048

(52) U.S. Cl. 715/784

(57) ABSTRACT

This document describes methods and/or apparatuses for enabling a window to be scrolled without the window having to be selected to become active or primary, along with other techniques.

### BACKGROUND

Conventional techniques for scrolling through a computing application's window that is not active or primary involve receiving selection of that window and then, following the window becoming active or primary, receiving a scrolling or slider input to the window, responsive to which, the now-active or now-primary window scrolls. If a user wishes to return to the previously active window, the user then selects that window to make it active.

### BRIEF DESCRIPTION OF THE DRAWINGS

FIG. 1 illustrates an environment in which techniques for input to non-active or non-primary windows can be employed.

FIG. 2 is a flow diagram depicting an example process, performed by a computer, for scrolling a non-primary or non-active window.

FIG. 3 illustrates an active or primary window obscuring part but not all of a non-active or non-primary window.

FIG. 4 illustrates the windows of FIG. 3 but with the non-active or non-primary window having been scrolled.

The same numbers are used throughout the disclosure and figures to reference like components and features.

### DETAILED DESCRIPTION

This document describes methods and/or apparatuses for enabling a window to be scrolled without the window having to be selected to become active or primary, along with other techniques.

### Example Environment

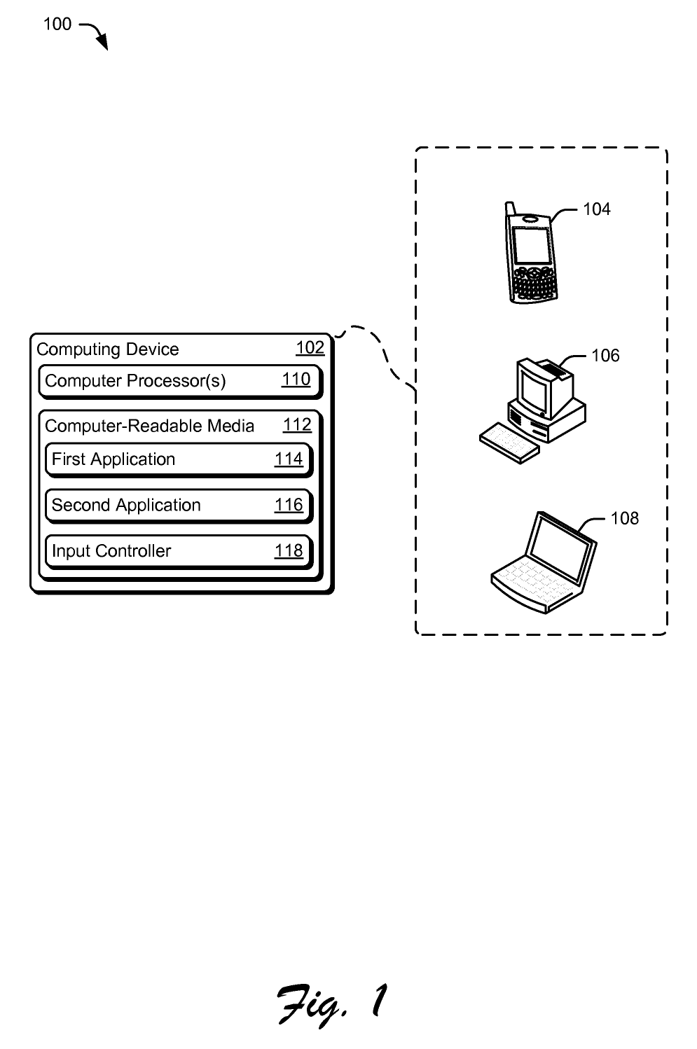

FIG. 1 is an illustration of an example environment 100 in which techniques for input to a non-active or non-primary window can be embodied. Environment 100 includes a computing device 102 along with three example computing devices: a smart phone 104, a desktop computer 106, and a laptop computer 108, though other computing devices and systems, such as servers and tablet computers may also be used.

Computing device 102 is illustrated having computer processor(s) 110 and computer-readable media 112. Computer-readable media 112 is storage media and includes first application 114, second application 116, and input controller 118. Each of applications 114, 116 is capable of having content presented with a window on a computing screen and through which the application may be interacted with. Input controller 118 is capable of receiving and handling inputs made to portions of a computing display, including those made over a non-active or non-primary window. Input controller may include, be part of, or interact with an operating system, one or more input devices and device drivers, and the like, such as a touch screen or a mouse.

Note that one or more of the entities shown in FIG. 1 may be further divided, combined, and so on. Thus, environment 100 illustrates some of many possible environments capable of employing the described techniques. Generally, any of the techniques and abilities described herein can be implemented using software, firmware, hardware (e.g., fixed-logic circuitry), manual processing, or a combination of these implementations. The entities of environment 100 generally represent software, firmware, hardware, whole devices or networks, or a combination thereof. In the case of a software implementation, for instance, the entities (e.g., input controller 118) represent program code that performs specified tasks when executed on a processor (e.g., computer processor(s) 110). The program code can be stored in one or more computer-readable memory devices, such as computer-readable media 112. The features and techniques described herein are platform-independent, meaning that they may be implemented on a variety of commercial computing platforms having a variety of processors. Ways in which entities of computing device 102 acts is set forth in greater detail below.

### Example Processes

The following discussion describes ways in which the techniques may operate to enabling input through a non-active or non-primary window. Aspects of these processes may be implemented in hardware, firmware, software, or a combination thereof. These processes are shown as sets of blocks that specify operations performed, such as through one or more entities or devices, and are not necessarily limited to the order shown for performing the operations by the respective blocks. In portions of the following discussion reference may be made to environment 100 of FIG. 1.

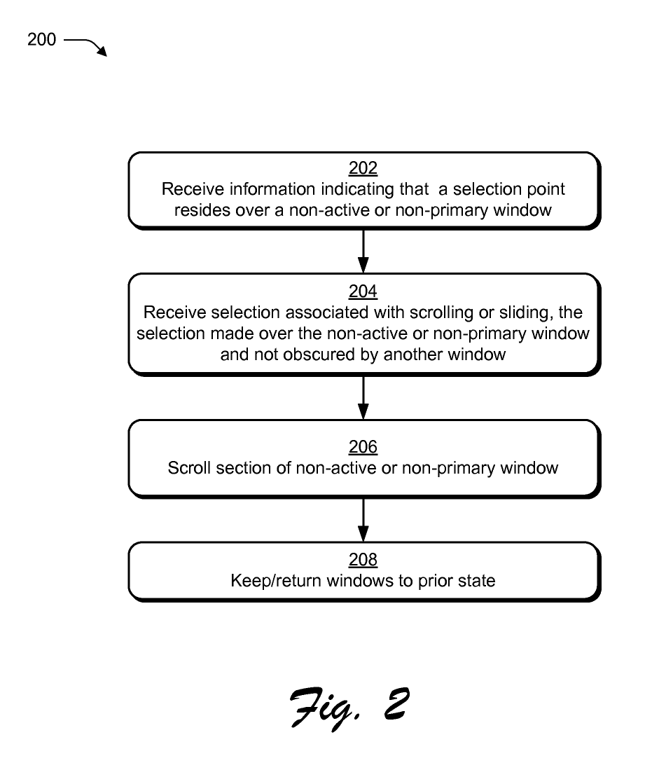

FIG. 2 is a flow diagram depicting an example process 200 for enabling input to a non-primary or non-active window.

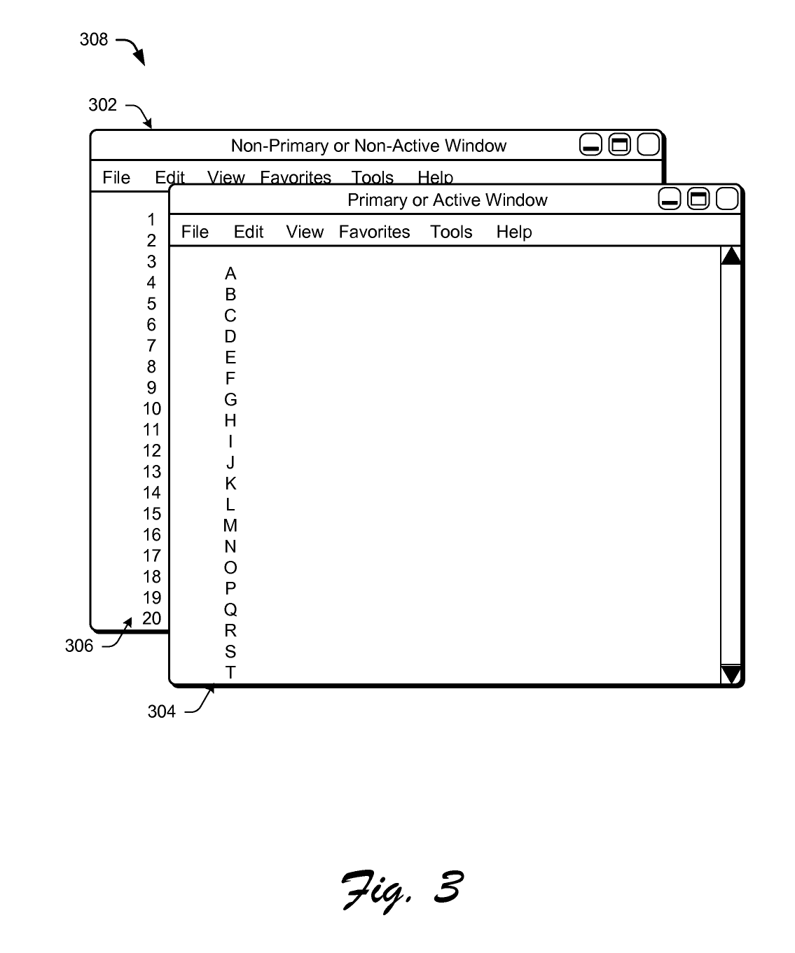

Block 202 receives information indicating that a selector or selection point resides over a non-active or non-primary window. By way of example, consider FIG. 3, in which non-primary or non-active window 302 is obscured by primary or active window 304. Note that the content 306 of window 302 is shown, as are potions of window 302 over which a selector can be placed.

Input controller 118 may receive information indicating that a selector or selection point (e.g., a mouse icon on a display or a finger touching a touch screen) resides over a non-active or non-primary window on one or more displays associated with computing device 102.

Block 204 receives a selection associated with scrolling or sliding, the selection made over the non-active or non-primary window and to a portion of the window not obscured by another window. This can be received over a section of the non-active or non-primary window that is capable of being scrolled that is also not obscured by the active or primary window. This can be handled by input controller 118, which may be part of a device handler or operating system capable of receiving coordinates of a selection or selector, as well as an indication of the selection being made. One example is a scrolling mouse where the selector is over the non-active or non-primary window and then a scrolling action is received (note that here the mouse has a scrolling mechanism, the selection being a rolling of the scrolling mechanism). Another is a person's finger touching a portion of the screen showing the non-active or non-primary window and then the finger or fingers making a gesture (like moving down the window). In still others it is through an un-obscured slider on the non-active or non-primary window.

In some embodiments additional information is received with the selection associated with scrolling, the selection indicating that the scrolling is to be made to a non-active or non-primary window. In some cases this additional information involves another button, gesture, or alteration to the gesture, scroll, or other conventional scrolling indication, this additional information indicating that the scrolling is to be made to a non-primary or non-active window. Further, this additional information with the selection may indicate that the currently primary or active window is to be active or return to being active either as soon as possible or not become non-primary or non-active. Thus, a mouse or other input may have a separate scrolling mechanism or other selector that indicates that the input to the non-active or non-primary window is intended for that window and/or that the input should be made to this window but that the window not become primary or active and thus obscure the current active or primary window (e.g., window 304).

Block 206 scrolls a section of the non-active or non-primary window as indicated in the selection received. This scrolling of the section of the non-active or non-primary window may not require a selection to make primary the non-primary or non-active window in which the section is included. Thus, a user may simply move a mouse pointer over the window and scroll without clicking on the window or having to make the window active or primary (or supersede the active window visually, though temporarily this may be the case, though the user may not be aware of it). Input controller 118 may handle such an input in various ways, such as to redirect an input that would otherwise be considered for the primary window based on the selector not being over the primary window (e.g., 304) but instead being over a visible section of window 302, such as the section showing content 306. Input controller 118 may show this scrolling or sliding also in various ways, such as to make window 302 active or primary, scroll/slide the section, and then either return the window 302 to its prior, non-active or non-primary state and window 304 to its prior state or it may keep that other window active. This may also be automatic and without showing this change other than to move the content (e.g., no appearance or visual change is made to the primary or active window). Note also that the non-active or non-primary window may not be obscured at all, though this is not required.

Process 200 may, but is not required, to proceed to block 208 to return the windows to their respective prior states.

By way of further example, consider the following optional embodiments.

In some embodiments, the scrolling is performed by making primary the non-active window having the section, then scrolling the section, and then making the now primary window having the section no longer active. This may be done with only a single input from the user, however. In some cases the techniques automatically make the active or primary window active again, and in some case returns the visual representation of the two windows to look the same as they looked prior to scrolling the section.

In some embodiments, receiving the information (e.g., the scrolling) includes receiving the information when the information would otherwise be directed to software associated with the active or primary window and redirecting the information to other software associated with the non-active or non-primary window having the section. In some embodiments, the receiving selection is also redirected in a similar manner.

In some embodiments, a software module or applet receives the information and selection (e.g., input controller 118), redirects it to software associated with the non-active or non-primary window, instructs the non-active or non-primary window to become active and then, after the scrolling is complete, instructing the window having the section to once again no longer be active or primary. Note that this may be done without the display making a visual change other than scrolling the section—this instead may be invisible to the user other than the scrolling made. This permits the user to continue without a visual or even noticeable actual interruption to the primary or active window 304.

The software module or applet may also or instead instruct the active or primary window to become active or primary again once the scrolling is complete in the other window. The method may perform this scrolling without altering the appearance of the windows or may alter the appearance. Thus, the non-active window having the section may appear active when (or if) it becomes active, then respond to the scroll selection by scrolling the section, and then when done scrolling become inactive or non-primary. The other window that was active will become active again, if it was made inactive. The appearance may not change other than the section scrolling.

By way of example, consider further the two windows in FIG. 3, here on a computer display 308, the windows being non-primary or non-active window 302 and primary or active window 304. The window 304 is active, and thus receives inputs made to it without first selecting that active window. This can be thought of as a software program or programs associated with the window 304 being the one that receive inputs from a user. The inputs are conventionally inputs made that do not use a graphical selection device (e.g., a mouse or touch pad) instead using keystrokes and the like, though this is not required. The inputs are conventionally also inputs made through a graphical selection device that are made to the portion of the display occupied by the window 304. If a user is working with the window 304 (e.g., a word-processing program having a window 304 in which the user is typing text) but is viewing content 306 of window 302 (e.g., a PDF program having a second, non-primary window that the user is viewing) and wants to continue typing in the window 304 with as little interruption as possible but also needs the window 302 to scroll or otherwise advance further on viewed page or to additional pages, the user conventionally moves a mouse pointer, clicks on the window 302 to make it primary/active, then scrolls while residing over a scrollable section or scroller/slider control to see more on the window 302, and then moves back to the window 304 and clicks (selects) it. Then the user keeps typing. Thus, the user will often need to move the mouse icon from the window 304 to the window 302, click on the window 302, scroll over the window 302, move the mouse icon or pointer back over to the window 304, and clink on the window 304 again. This can be inefficient.

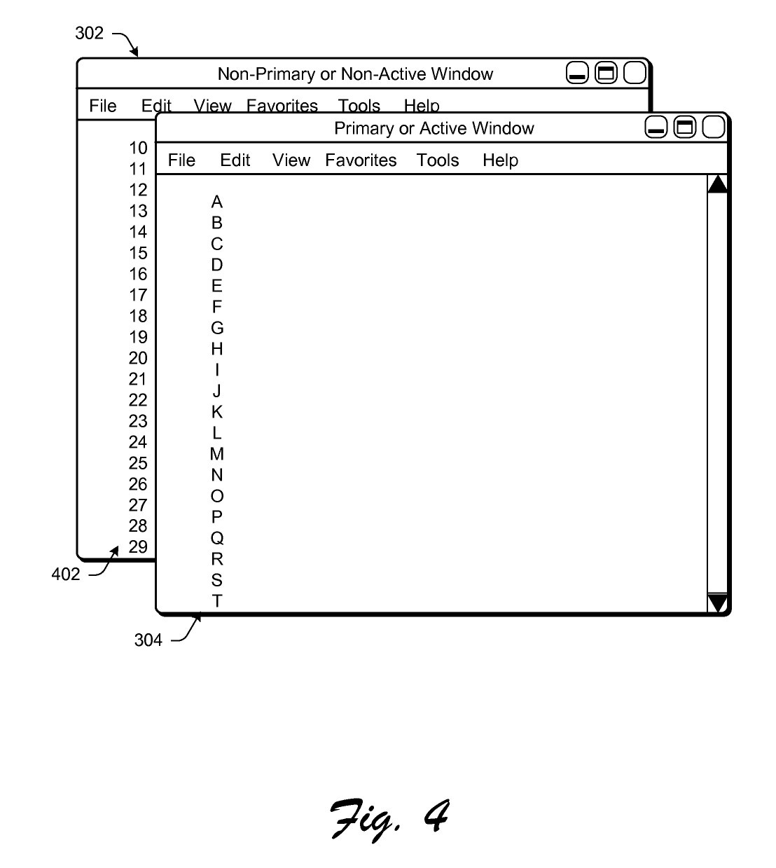

As noted herein in part, these techniques may enable a user, in some examples, to keep the mouse pointer over the second, non-active window (here the PDF in window 302) and scroll it without further action. The software associated with window 302 scrolls the window (responsive to input controller 118). This is shown in FIG. 4, which illustrates scrolling of content in section 402 of FIG. 4 compared to section 306 shown in FIG. 3.

In some embodiments this user does not need to move the mouse at all or select the second window to activate it. Instead, the user simply scrolls with the pointer residing over the section of the second window that is capable of scrolling (or a scroller/slider control) or would be capable if the window is active or primary and uses another input device (e.g., a keyboard) to continue work on or viewing of window 304. In this example two moves of the mouse and two clicks are saved. In some examples, such as making the second window become primary, fewer clicks may be saved, though at least a move or click or other selector is saved in each case.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A computer-implemented method comprising:
receiving information indicating that a selector resides over a non-active or non-primary window on one or more displays associated with a computing device, the one or more displays having an active or primary window;
receiving a selection associated with scrolling or sliding, the selection made with the selector residing over a section of the non-active or non-primary window that is capable of being scrolled and that is not obscured by the active or primary window; and
responsive to receiving the selection, scrolling the non-active or non-primary window without requiring a selection to make primary the non-primary or non-active window in which the section is included.

2. The computer-implemented method of claim 1, further comprising maintaining the visual appearance of the active or primary window.

3. The computer-implemented method of claim 1, wherein scrolling the non-active or non-primary window is performed without altering an appearance of the active or primary window.
